(19) United States
(12) Patent Application Publication
(10) Pub. No.: US 2002/0093203 A1
(43) Pub. Date: Jul. 18, 2002

(54) Detent window latch

(76) Inventor: Ralph D. Moretz, Jackson, MI (US)

Correspondence Address: DUNCAN F. BEAMAN, YOUNG & BASILE, P.C., 3001 WEST BIG BEAVER ROAD, SUITE 624, TROY, MI, 48084, US

(21) Appl. No.: 09/758,662

(22) Filed: Jan. 12, 2001

(51) Int. Cl. E05C 5/00; E05C 19/10

(52) U.S. Cl. 292/113; 292/95

(57) ABSTRACT

A detent system particularly suitable for pivotal automotive windows, but not limited to such use, wherein the components are molded of a synthetic material and wherein a first member pivotally supports a second member and the second member is pivotally positioned between detent maintained positions. The detent action is achieved by shaping and sizing the relative members such that deformation between the relative members occurs during relative rotation such that the changing resistance to relative rotation, because of the interlocking configuration of the members, a detent action is achieved.

### BACKGROUND OF THE INVENTION

1. Field of the Invention

The invention pertains to latches having relatively rotatable members wherein a detent action for locking the members in relative relationship is achieved by resilient deformation of one, or both, of the members.

2. Description of the Related Art

Many of the pivotally mounted windows in contemporary automobiles, vans and trucks, particularly the rear side windows of truck cabs, or sun roof panels, utilize a latch which permits the associated unhinged edge of the window to be partially opened for ventilation purposes. By the partial pivotal opening of such windows, and as the rearward window edge is open, a venturi effect is produced which pulls air through the vehicle passenger space, and reduces the entry of rain into the cabin. Such latches normally pivot between a fully open position and a fully closed position causing the window or glass panel to seat against resilient sealing structure.

Conventionally, such window latches basically consist of a pivotal first member which is of such shape as to function as a handle, and a second member pivotally mounted to the first member having a link extending therefrom.

In the fully open position of known latches of this type, an over-center relationship of the window link is usually used to hold the window closed in that the latch structure is in its retracted or closed position. When the latch structure is in its open or extended position, an over-center link relationship may also be used, but in many instances, various types of detent knobs or projections are employed. Examples of such types of window latches are shown in U.S. Pat. Nos. 4,466,644 and 4,469,370.

It is desirable to produce molded synthetic plastic latch members which are capable of a long effective life for holding window or glass panels in closed and open positions, and the invention deals with improved constructions for window latches which are easy to operate, effectively hold the window in desired positions, and inexpensive to manufacture and assemble.

### OBJECTS OF THE INVENTION

It is an object of the invention to provide a latch having detent maintained operative positions which is molded of a synthetic material, is self-lubricating, and does not require secondary machining operations.

Another object of the invention is to provide a latch system formed of resilient molded thermoplastic members relatively pivotal to each other wherein such pivotal movement is releasably locked or positioned by resilient detent structure built into the configuration of the members.

An additional object of the invention is to provide a latch system including a pair of molded synthetic members pivotally related to each other wherein the pivoting action is self-lubricating, a releasable detent action is achieved at predetermined pivotal relationships between the members, and the members may be inexpensively manufactured.

### SUMMARY OF THE INVENTION

Basically, a latch detent system in accord with the inventive concepts includes two members pivotally interconnected for relative rotational movement. While it would be possible to practice the inventive concepts with the detent latch system members being formed of any resiliently deformable material, such as steel or aluminum, preferably, the members are molded of a high strength synthetic self-lubricating material which would usually be of a thermoplastic nature, such as nylon, acetal or polyacetal.

The first member may be designated the handle and supports the second member which is rotatable received within spaced sockets defined in the first member. The second member also has a link extending therefrom whose length is transversely related to the length of the second member.

The first member will usually be of a handle form which is easy to grasp and push against. Usually, the first member will include a flat portion against which the palm may be applied, and a pair of spaced supports are defined on the first member. These supports are parallel to each other and resiliently deformable away from each other to a limited extent. Preferably, the supports each include a blind socket defined by a non-circular circumference, and a bottom surface. An elongated U-shaped recess is formed in each socket bottom surface generally diametrically related to the associated socket.

The second member is of an elongated configuration having axially extending end portions and terminating ends and surfaces. The end portions are of a non-circular peripheral configuration complementary in shape to the socket wall configurations so that the end portions may be closely received therein. Preferably, the second member end portions are of a generally elliptical configuration complementary to the generally elliptical configuration of the first member sockets.

The second member end portions are preferably of a general C-shaped transverse cross sectional configuration capable of being deformed inwardly, but could be of a closed elliptical shape. Also, the second member end terminating surfaces are formed with elongated projections complementary in configuration to the elongated recesses defined in the first member socket bottom surfaces, and are of a generally U-shaped transverse sectional configuration.

A link integrally extends from the second member having a length generally perpendicular to the length of the second member, and includes connecting structure at its end for attachment to window hardware. Preferably, the link is homogeneously formed of the same material as the second member.

The first and second members are assembled by deforming the first member supports away from each other sufficiently to permit the second member end portions to be received within the sockets of the supports. Once the second member is in place and aligned with the first member sockets, the first member supports are permitted to return to their natural position which encases the second member end portions within the sockets and the second member terminal end surfaces will be in engagement with the socket bottom surfaces. Preferably, in order to prevent mistakes during assembly, the diametrical dimensions of one of the first member sockets and one of the end portions of the second member are slightly greater than the other socket and the other end portion preventing erroneous assembly of the first and second members.

With the first and second members assembled as described above, relative pivoting of the second member to the first member is possible. The sockets are coaxial, as are the end portions, and relative pivoting of the second member relative to the first member causes the second member end portions to be radially inwardly deformed due to the non-circular configuration of the sockets'circumferences. This produces a resistance to relative rotation of the first and second members, but once sufficient rotation has occurred so that the end portions of the second member are permitted to expand, a detent relationship between the first and second members is produced.

It will be appreciated that when using a self-lubricating material to form the first and second members, the frictional rotation of the members would be lubricated, and relative rotation is not difficult to achieve.

The detent locking action produced by the contraction and subsequent expansion of the second member end portions is augmented by the projections defined on the second member terminating end surfaces aligning with and entering the recesses defined on the first member socket bottom surfaces. This alignment, and reception of the projections into the recesses produces a distinctive snap action or “click”, and indicates to the operator that a locking detent action has occurred. When it is desired to reverse the action of the latch, force is applied to the first member by the operator permitting the projections to slide out of the recesses and again compressing the second member end portions such that resistance to relative pivoting between the first and second member occurs until once again the surfaces of the sockets correspond to the configuration of the second member end portions and a detent locking relationship between the first and second member again occurs.

In a variation of the invention, radial projections are defined on the exterior of the second member to engage with a deformable portion formed on the first member thereby producing a detent locking relationship between the members. With this embodiment, the second member end surface projections and first member socket bottom surface recesses may also be used, as can the non-circular configuration of the sockets and end portions.

Preferably, the non-circular configuration of the first member sockets and the second member end portions is of an elliptical or oval shape. However, it will be appreciated that other non-circular configurations will achieve similar results due to the compression and radial inward deformation of the second member end portions. For instance, hexagonal configurations could be used to provide several detent locking relationships during each relative full pivoting action of the first and second members.

### BRIEF DESCRIPTION OF THE DRAWINGS

The aforementioned objects and advantages of the invention will be appreciated from the following description and accompanying drawings wherein:

FIG. 1 is a plan assembly view of a latch using the inventive concepts illustrating the window structure to which the latch is attached,

FIG. 2 is a perspective underside view of latch first and second members as assembled,

FIG. 3 is an end view of the first member,

FIG. 4 is an elevational sectional view as taken through the first member of FIG. 3 along Section 4-4 of FIG. 3,

FIG. 5 is an elevational sectional view taken through the first member along Section 5-5 of FIG. 4,

FIG. 6 is a perspective view of the second member, per se,

FIG. 7 is an end view of a second member of another embodiment of a toggle link,

FIG. 8 is a view of the second member of FIG. 7 as taken from the left thereof,

FIG. 9 is an elevational sectional view taken along Section 9-9 of FIG. 10,

FIG. 10 is an end elevational view as taken from the right of FIG. 9,

FIG. 11 is a sectional view similar to the elevational view of FIG. 1 but in section and utilizing the toggle link of FIG. 7, and

FIG. 12 is a view of the toggle link association with the window structure as taken along Section 12-12 of FIG. 11.

### DESCRIPTION OF THE PREFERRED EMBODIMENTS

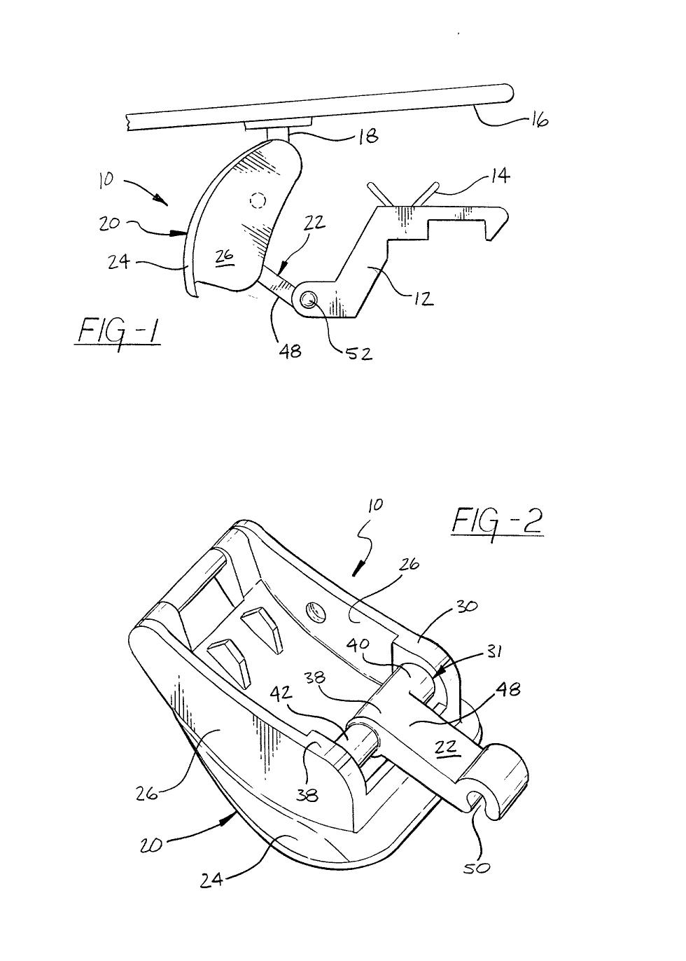

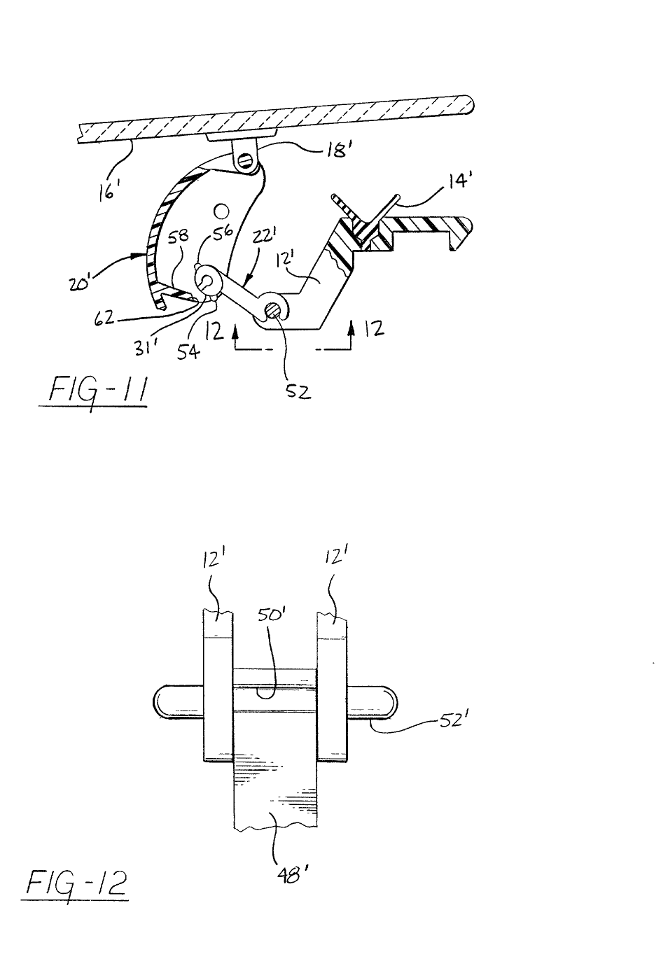

With reference to FIG. 1, a detent latch utilizing concepts of the invention is generally indicated at 10. The window structure 12 mounted upon the vehicle window opening (not shown) is usually formed of a synthetic plastic which closely fits the window opening in a sealed relationship, and includes the V-shaped seal 14, see FIGS. 1 and 11, which contact the glass window 16 which is pivotally mounted to window structure 12 at a forward location of the window, not shown, as is well known in the automotive art.

A window anchor 18 is bonded or otherwise attached to the window 16, and the detent latch structure of the invention is mounted upon the window anchor 18 for pivoting the window 16 from an open position as shown in FIG. 1, to a closed position wherein the window 16 sealingly engages the seal 14.

The first member of the latch 10 comprises a handle 20 which is of a generally convex configuration so that the exterior of the handle can be pushed by the palm of the hand, and the edges of the handle extend beyond the handle understructure on the opposite side thereof so that the user's fingers may grasp the handle to release the latch from its locked position. A toggle link 22 is pivotally mounted upon the handle 20, as later described, and the handle cover 24 is relatively flat whereby the palm of the hand may be applied against the cover 24 to pivot the latch 10 to its locked condition pivoting the window 16 into engagement with the seal 14.

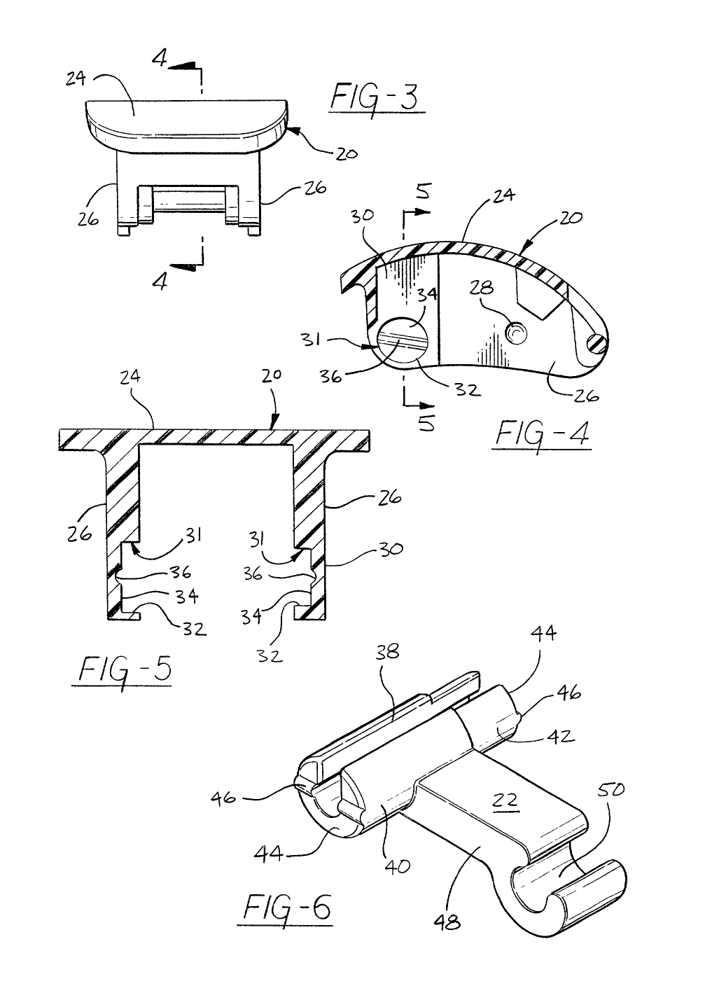

Inside the handle cover 24, side elements or link supports are shown at 26, the sides 26 being homogeneously molded of the same material as the handle cover 24. A pivot bar 28 is formed between the sides 26, FIGS. 2 and 4, to pivotally receive the window anchor 18, as is apparent in FIG. 11.

The thickness of the sides 26 is increased at 30 to define bosses in which bearing sockets 31 for the toggle link 22 are formed. The bearing sockets are each defined by an elliptical surface 32 and a bottom surface 34 perpendicularly disposed to the surface 32. Accordingly, it will be appreciated that the sockets 31 constitute blind holes and they are coaxially aligned with each other. The elliptical configuration of the socket surfaces 32 will be appreciated from FIG. 4, and as noted in FIG. 5, the coaxial sockets 31 are of a different diametrical dimension for a purpose later explained.

The bottom surface 34 of each of the sockets 31 is provided with an elongated U-shaped recess 36 which is located in a substantially “diametrical” relation to its associated socket.

The toggle link body 38 is of an elongated configuration having a large end portion 40 and a smaller end portion 42, FIG. 6. Each of the end portions terminates in a terminating end 44 perpendicularly disposed to the axis of the body 38. An elongated U-shaped projection 46 extends from each terminating end surface 44, and is of a configuration and dimension as to be received within a socket recess 31 when aligned therewith. The toggle body 38, which constitutes the second member of the detent latch, includes the elongated link arm 48 which is, preferably, homogeneously molded of the material of the body 38, and the link arm 48 terminates in a C-shaped pin recess 50 for pivotally receiving the pivot pin 52 mounted upon the window structure 12, FIG. 1.

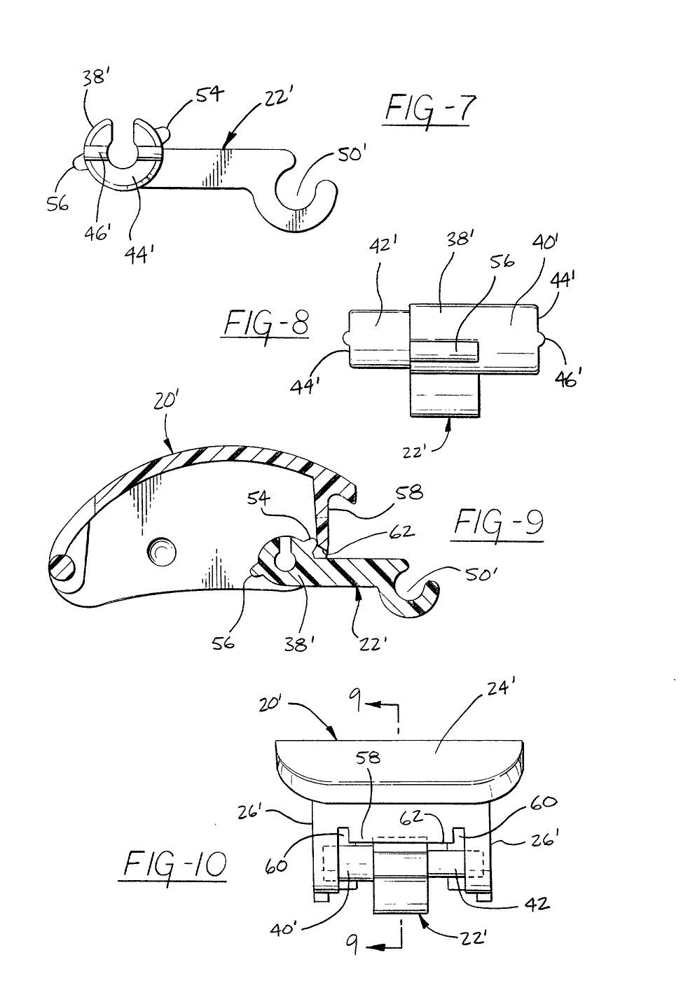

The toggle body 38 is of a hollow C-shaped configuration as will be appreciated from FIGS. 6 and 7. This C-shaped configuration of the toggle body 38 permits the toggle body to be inwardly deformed as the synthetic material from which the toggle body is molded is of a relatively rigid elastically deformable self-lubricating material, such as nylon, polyacetal, or the like.

The handle 20 and the toggle link 22 are preferably assembled by momentarily separating the sides 26 sufficiently to align the toggle body end portions 40 and 42 with the appropriate sockets 31 while the handle 20 is still hot from molding and not fully cured. Upon releasing the sides 26, the end portions 40 and 42 will be firmly received with the sockets 31, and as the dimensions and configuration of the socket surfaces 32 are slightly greater than the dimensions of the toggle body end portions 40 and 42, but of similar configuration, the toggle link 22 will be pivotally attached to the handle 20 in a strong mechanical manner.

Because the end portion 40 is of a greater diametrical dimension than the toggle body end portion 42, and because the sockets 31 are of different diametrical dimension to correspond to the toggle body end portions, it is not possible to mistakenly assemble the toggle link 22 to the handle 20 rendering the assembly of these components foolproof.

When the toggle link 22 is rotated relative to the handle 20 and sockets 31, the configuration of the sockets, being non-circular, will deform the toggle body 38 end portions inwardly providing a resistance to relative rotation between the handle 20 and the toggle link 22 but once the maximum dimension of the sockets realign with the maximum dimension of the toggle link end portions, the toggle body will expand to its normal configuration providing an indexed detent relationship between the handle 20 and toggle link 22.

A further augmentation of the indexed detent relationship between the handle 20 and toggle link 22 is achieved by the reception of the projections 46 defined on the toggle body terminating ends 44 with the recesses 36 defined in the socket bottom surfaces 34. As the toggle link 22 is rotated relative to the handle 20, the projections 46 will ride out of the recesses 36 slightly resiliently separating the handle sides or toggle body supports 26 in a resilient manner. Once sufficient relative rotation has occurred, the projections 46 will again align with the recesses 36 permitting the side supports 26 to move inwardly further adding to the locked detent relationship between handle 20 and toggle link 22, and providing a “click” action capable of being sensed by the operator.

As the handle 20 and toggle link 22 are pivotally mounted to the window anchor 18 and the window structure 12, the relative pivoting occurring between the handle 20 and toggle link 22 moves the window 16 between its open and closed positions. The detent operation between the handle 20 and toggle link 22 achieved by the configuration of the socket surfaces 32 and the end portions 40 and 42, and the interlocking relationship between the projections 46 and recesses 36, are so related that the window will be held in its open position. Upon pivoting the handle 20 and toggle link 22 in the opposite direction, the window 16 will be brought against the seal 14 to the closed position which will be maintained by the detent action, or if desired, a “over-center” relationship between the pivot bar 28 and pin 52 can be utilized as is well known with this type of latch.

FIGS. 6-12 disclose a variation in the detent action which may be achieved utilizing the inventive concepts, and as much of the structure is similar to the embodiment previously described, common and identical components are referenced by primed numerals.

In the embodiment of FIGS. 6-12, cams 54 and 56 are defined upon the central region of the toggle body 38′. These cams cooperate with a bridge 58 defined on the handle 20′ between the sides 26′, FIG. 10. The bridge 58 is defined by slots 60 permitting the bridge to be cantilever supported and defined by an edge 62 which, because of the resilient nature of the material of which the handle 20 is formed, is capable of limited movement when engaged by a cam 54 or 56. Accordingly, the cams 54 and 56 may be so positioned as to augment the detent action achieved by the socket non-circular configuration and the projection and recesses.

It is appreciated that various modifications to the inventive concepts may be apparent to those skilled in the art without departing from the spirit and scope of the invention.

1. A latch detent characterized by its low cost and self-lubricating ability comprising, in combination, a first member having a pair of spaced opposed bearing supports each having a socket defined therein forming first and second sockets, each socket having a circumference and a longitudinal axis defined thereby, the axes of said sockets being coaxial, a second member molded of a self-lubricating synthetic material comprising an elongated body having an axis and an integral link transversely disposed to said body axis, said body having first and second terminating ends each having a circumference and an axis, the axes of said body ends being coaxial, said first body end being received within said first socket and said second body end being received within said second socket, said first socket being non-circular, said first body end being non-circular and firmly received within said first socket, said first body end being resiliently radially deformable and so shaped that relative rotation of said first body end within said first socket produces resistance to relative rotation as said first body end is deformed during a predetermined extent of rotation and a detent locking relationship between said members when said first body end radially expands at another relative rotational relationship between said first socket and first body end.

2. A latch detent as in claim 1, said second socket and said second body end each being of a non-circular configuration firmly rotatable engaging each other, said second body end being resiliently radially deformable, said second socket and second body end being rotationally oriented to said first socket and first body end as to simultaneously produce a detent locking relationship therewith.

3. A latch detent as in claim 2, the transverse dimensional size of said first socket and said first body end being greater than the transverse dimensional size of said second socket and said second body end to eliminate erroneous assembly of said first and second members.

4. A latch detent as in claim 2, said first body end having a C-shaped transverse cross sectional configuration.

5. A latch detent as in claim 1, said first socket and said first body end having a substantially elliptical transverse cross section.

6. A latch detent as in claim 2, said first and second sockets and said first and second body ends having a substantially elliptical transverse cross section.

7. A latch detent as in claim 1, at least one of said sockets being a blind hole having a bottom surface, a first detent configuration defined on said one socket surface bottom, said body end received within said one socket having a terminating surface, and a second detent configuration defined on said terminating surface adapted to releasably interlock with said first detent configuration at a predetermined rotational relationship of said first and second members.

8. A latch detent as in claim 7, both of said sockets comprising a blind hole having a bottom surface, each of said body ends including terminating surfaces, said first member bearing supports being resiliently supported and so spaced that the axial distance between said sockets' bottom surfaces is normally slightly less than the axial distance between said body ends' terminating surfaces whereby said bottom surfaces are resiliently biased into engagement with said terminating surfaces.

9. A latch detent as in claim 8 wherein interlockable detent configurations are defined upon both bottom surfaces and said terminating surfaces.

10. A latch detent characterized by its low cost and self-lubricating ability comprising, in combination, a first member having a pair of spaced opposed bearing supports resiliently supported, each having a blind socket having an axis and consisting of a circumference and a bottom surface, said sockets' axes being coaxial and said bottom surfaces facing each other, a second member having an elongated body and an integral link, said body having coaxial ends adapted to be rotatable received within said sockets, each body end each including a terminating surface engaging the associated socket bottom surface, a first axially extending detent configuration defined on said bottom surface, and a second axially extending detent configuration defined on said terminating surfaces releasably interlocking with said first detent at a predetermined rotational relationship between said first and second members.

11. A latch detent as in claim 10, said first detent configuration comprising an elongated recess and said second detent configuration comprising an elongated projection adapted to enter said recess when aligned therewith.

12. A latch detent characterized by its low cost and self-lubricating ability comprising, in combination, a first member having a pair of spaced opposed bearing supports each having a socket defined therein forming first and second sockets, each socket having a circumference and a longitudinal axis defined thereby, the axes of said sockets being coaxial, a second member molded of a self-lubricating synthetic material comprising an elongated body having an axis and an integral link transversely disposed to said body axis, a cantilevered deformable detent abutment defined on said first member having a free edge and a detent cam mounted on said second member, said cam engaging said abutment free edge and deforming said abutment to slide under said free edge to produce a predetermined detent stop with respect to relative rotation between said first and second members.
